(19) United States
(12) Patent Application Publication
(10) Pub. No.: US 2025/0030114 A1
(43) Pub. Date: Jan. 23, 2025

(54) PROTECTIVE DEVICE FOR BATTERY CELLS

(71) Applicant: John Deere Electric Powertrain LLC, Moline, IL (US)

(72) Inventors: Helmut Kastler, Freistadt (AT); Manuel Riegler, Freistadt (AT)

(21) Appl. No.: 18/708,881

(22) PCT Filed: Sep. 30, 2022
(86) PCT No.: PCT/AT2022/060343

§ 371 Date: May 9, 2024

(30) Foreign Application Priority Data
Nov. 11, 2021 (AT) A50901/2021

(51) Int. Cl. H01M 50/308; H01M 50/213; H01M 50/358

(52) U.S. Cl. CPC H01M 50/308; H01M 50/358; H01M 50/213

(57) ABSTRACT

A protective device for battery cells, comprises a hazard receptacle (1) for the outgassing region (2) of a battery cell (3) and a protective receptacle (5) located opposite the hazard receptacle (1) in a main direction (4). An outgassing channel (6) extending transversely to the main direction (4) for discharging hot gas is provided between the hazard receptacle (1) and the protective receptacle (5). The hot gases from a battery cell are vented in the event of a malfunction so that damage to or displacement of the components by the kinetic and thermal energy of the hot gases is avoided as much as possible. A protective element (7), which in a rest position covers the hazard receptacle (1), can be displaced by escaping hot gas along a guide into a trigger position covering the protective receptacle (5).

### FIELD OF THE INVENTION

The invention relates to a protective device for battery cells having a hazard receptacle for the outgassing region of a battery cell and a protective receptacle located opposite the hazard receptacle in a main direction, wherein an outgassing channel extending transversely to the main direction is provided between the hazard receptacle and the protective receptacle for discharging hot gas.

### DESCRIPTION OF THE PRIOR ART

Protective devices for outgassing battery cells are known from the state of the art. These battery cells have an outgassing region, for example the area of the positive terminal, in which a predetermined breaking point is provided as an outgassing valve through which hot gases that occur in the event of a fault can escape from the interior of the battery cell. As these hot gases can damage neighboring components in the vicinity of the outgassing battery cell, for example other battery cells, outgassing channels can be provided, as shown in AT521257A4, for example, which specifically discharge the hot gases. The outgassing channels of AT521257A4 are formed by a device for contacting two battery cells and are designed in such a way that the hot gases are deflected into an outgassing channel running transverse to the joining direction of the battery cells, thereby reducing the heat transfer from the hot gases to neighboring battery cells.

A disadvantage of the prior art, however, is that not only high amounts of thermal energy but also kinetic energy are released during degassing, which causes the battery cell or other components to be pushed out of position or to be damaged. If the outgassing channel were simply enlarged in order to reduce the pressure and consequently the kinetic energy of the hot gases, the hot gases would remain in the outgassing channel for longer after the pressure has been reduced and could transfer their thermal energy to neighboring components more easily. In addition, the distance between the hot gases and the neighboring components is reduced for a given component distance and larger outgassing channel, which further favors undesired heat transfer.

### SUMMARY OF THE INVENTION

The invention is therefore based on the task of dissipating the hot gases from a battery cell in the event of a fault, particularly when battery cells and/or other sensitive components are densely packed, in such a way that damage to or displacement of the components by the kinetic and thermal energy of the hot gases is avoided as far as possible.

The invention solves the problem posed by the fact that a protective element covering the hazard receptacle in a rest position can be displaced by escaping hot gas along a guide into a trigger position covering the protective receptacle. During normal operation of the battery cell, the outgassing region of the battery cell located in the hazard receptacle is covered from the outgassing channel by the protective element, which prevents damage to the outgassing region of the battery cell, in particular the predetermined breaking point forming the outgassing valve, by hot gas flowing in the outgassing channel. If, on the other hand, a malfunction occurs in the battery cell located in the hazard receptacle, the outgassing hot gases and/or electrically conductive particles transfer their kinetic energy at least partially in the form of an elastic impact to the protective element, which thereby shifts along the guide in the direction of the protective receptacle. As a result, the protective element not only removes kinetic energy from the gas, but also allows the hot gas to enter the outgassing channel running between the hazard receptacle and the protective receptacle transversely to the main direction. To enable this entry, the protective element does not have to move into the trigger position, in which it covers the protective receptacle, but only leave the rest position along the guide. If the escaping hot gases are so energetic that the protective element absorbs so much kinetic energy that it not only leaves the rest position but is displaced into the trigger position, the protective element forms a physical barrier to the protective receptacle by covering it. This physical barrier, which is preferably electrically insulating, acts not only against escaping hot gases, but also against other electrically conductive solid residues caused by faults, which can lead to short-circuit reactions. A neighboring component, for example another battery cell, can be arranged in the protective receptacle. As the protective element is displaced further and further along the guide away from the rest position towards the trigger position in proportion to the kinetic energy transferred, the opening to the outgassing channel also increases as the kinetic energy of the gas increases. The shape and mass of the protective element can be adapted to the kinetic energy of the gas that is expected to be released, so that it absorbs more or less of the kinetic energy of the gas without allowing the resulting counterforce to displace or further damage the battery cell.

In order to prevent escaping hot gases from damaging other parts of the protective device and at the same time to enable favourable design conditions, the guide can have a guide bar arranged at the edge of the protective element and extending in the main direction. As a result of these measures, the area between the outgassing region of the battery cell and the protective receptacle can be kept largely installation- free, apart from the required protective element, so that the hot gas cannot attack any other components. As guide bars can be geometrically simple and do not include any moving parts to fulfil their function, they are also less susceptible to wear and are easy to manufacture, for example by injection moulding. In order to prevent undesired displacement of the protective element during the transition to the trigger position, a guide groove can be provided in the protective element, in which the guide bar engages as a tongue.

In order to enable a tilt-free, uniform displacement of the protective element into the trigger position by simple design means, it is proposed that the guide a plurality of guide bars equally distributed on the circumference of the protective element. As a result of these measures, a positive fit is created between the guide bars and the protective element transverse to the main direction, whereby the protective element is held in position even by high kinetic energy transfer from the hot gas and can only be displaced along the guide from the rest position to the trigger position without further bearing elements. Furthermore, the equally distributed arrangement of the guide bars prevents the protective element from tilting on a guide bar, as the resistance between the protective element and the guide that occurs during the displacement is thus inevitably equally distributed over the edge and the protective element is thus accelerated evenly over its entire surface.

So that the battery cell can be easily electrically contacted despite the protective device provided without impairing the protective function of the protective device, the protective element can have a recess for the passage of a connecting conductor, which recess is arranged offset transversely to the main direction with respect to the outgassing region of the battery cell. This is based on the consideration that the escaping hot gases do not escape via the entire end section of the battery cell included in the hazard receptacle, but rather locally in concentrated form via a preferred predetermined breaking point, which can be formed as an outgassing region by an outgassing valve, for example. Due to the offset arrangement of the recess to the outgassing region transverse to the main direction, a connecting conductor can be routed through the recess to another battery cell or a consumer, for example, without the hot gases also being routed directly through this recess. This means that the hot gases can still transfer their kinetic energy to protective element's part above the outgassing region not having a recess and be channeled into the outgassing channel. Since the outgassing region of a cylindrical battery cell is usually arranged radially offset to the positive terminal, in a preferred embodiment the recess can be provided in the centre of the protective element. In a further embodiment, the connecting conductor can be connected to the protective element in a tension-proof manner. In this way, the electrical connection of the battery cell can also be disconnected if the protective element is displaced due to a fault. In an alternative embodiment, the connecting conductor can also be a connecting pin on which the protective element is slidably mounted and which is preferably connected via a fuse to a contact point arranged in the protective receptacle. The contact point can be a contact spring for contacting a battery cell held in the protective receptacle on the casing side. The fuse can be covered with a heat shield towards the outgassing channel and thus also towards the protective element on the one hand and towards the protective receptacle on the other. This heat shield can, for example, consist of a mineral, in particular from the mica group.

In order to achieve a high energy density despite the use of the protective device, especially when connecting several battery cells, it is proposed that the hazard receptacle, the protective element and the protective receptacle are arranged concentrically to each other in the main direction. This arrangement enables a dense packing of several groups of battery cells and thus facilitates in particular the interconnection of battery cells arranged in series in the main direction. Furthermore, the distance to be bridged by the protective element from the rest position to the trigger position can be minimised as a result, whereby less kinetic energy has to be transferred from the escaping hot gases to the protective element for displacement to the trigger position.

In order to prevent unwanted displacement of the protective element, regardless of the spatial orientation of the protective device or any vibrations, the protective element can be secured against displacement from the rest position with a triggering acceleration of less than 100 g. Tests have shown that unwanted displacement can be avoided at this triggering acceleration, but that the escaping hot gases apply the force proportional to this triggering acceleration in order to cause the protective element to move into the triggering position. The protective element can be held in the rest position force-fittingly, for example by a spring. Alternatively or additionally, the protective element can also be fixed in the rest position form-fit or material-connected, whereby a predetermined breaking point can be provided, which breaks when a force corresponding to an acceleration of 100 g is exceeded. The force proportional to the triggering acceleration can be calculated by multiplying the triggering acceleration by the mass of the protective element. For example, the protective element can have retaining tabs that break when the force proportional to the triggering acceleration is exceeded.

The mechanical stability and reliability of the protective device during operation can be increased, particularly when several battery cells are arranged, if the protective receptacle is formed by a cylindrical recess of a socket, the outer side of which facing the outgassing channel forms a stop for the protective element in the trigger position. As a result of these measures, a strong kinetic energy transfer to the protective element does not cause any displacement beyond the stop, whereby the trigger position can be spatially defined and the protective element in the trigger position not only covers the protective receptacle, but can even rest against the protective receptacle. The cylindrical recess in the socket can also accommodate a further battery cell on the casing side and thus provide stable support. Furthermore, the guide for the protective element can be fitted to the socket, whereby the relative positions of the guide, the protective element and the protective receptacle can be fixed so that there is no relative displacement of these components in relation to each other in the event of operational vibrations, for example.

In order to prevent the protective device from becoming detached from the battery cell in the event of a fault due to the outgassing hot gases and to prevent the hot gases from not being reliably channeled into the outgassing channel, it is proposed that the hazard receptacle comprises a plurality of snap-in connections for fixing the battery cell. As a result of these measures, the protective device can be arranged on a battery cell form-fit and/or force-fit. For this purpose, the snap-in connections can engage in a circumferential groove of the battery cell or simply clamp it. In a preferred embodiment, the snap-in connections are formed by the guide bars, whereby an area between the protective receptacle and the hazard receptacle remains free as an outgassing channel. In a preferred embodiment, the protective element has at least one retaining tab, which engages behind the end section of a snap-in connection or guide bar facing away from the outgassing channel, so that the end section forms a stop limit for the retaining tab in the main direction. For this purpose, the retaining tab can protrude from the protective element in the opposite direction to the main direction. The kinetic energy transferred by the escaping hot gases causes the retaining tab to break at a predetermined breaking point, which allows the protective element to be displaced from its rest position. If the snap-in connections are formed by the guide bars, the protective element can be guided along the guide bars via the broken retaining tab. In a preferred embodiment, the protective element has a plurality of retaining tabs distributed around the circumference, whereby in particular a retaining tab can be provided for each snap-in connection.

For example, the protective device can have a socket with a cylindrical recess forming the protective receptacle, to which recess several guide bars are attached on the side opposite the cylindrical recess, which guide bars form the hazard receptacle between them. These guide bars run through the outgassing channel in an area adjacent to the socket. In an area adjacent to the outlet channel, the guide bars can form snap-in connections for securing the battery cell in the hazard receptacle. Particularly in the event that a battery cell is also mounted in the protective receptacle of the end sections, the socket, like the protective element, can have a through- opening for a connecting conductor for electrical contacting of the two battery cells.

The battery cells can preferably be cylindrical battery cells with a circular base, which are contacted with each other in series through the protective device.

The invention also relates to a battery system with a plurality of protective devices according to the invention which are adjacent to one another transversely to the main direction. In such a battery system, the end sections of battery cells of a first group are inserted into the hazard receptacles of the protective devices and the end sections of battery cells of a second group are inserted into the protective receptacles of the protective devices. A continuous outgassing channel is formed between the two groups by the protective devices. If an incident occurs in a battery cell in a hazard receptacle that leads to the escape of hot gas and/or electrically conductive particles, the protective element of the protective device placed on this battery cell is moved from the rest position to the trigger position, which not only prevents the escaping hot gas from reaching the neighbouring battery cell in the main direction, but also diverts it into the continuous outgassing channel. As the redirected hot gas flow in the immediate vicinity of the outgassing battery cell also has a directional component directed against the main direction by bouncing off the protective element, the surrounding battery cells transverse to the main direction are protected from the hot gas, but also from electrically conductive solid residues caused by faults, by the protective elements of the neighbouring protective devices in the rest position. In particular, the hot gas flow is thus kept away from the outgassing regions of the surrounding battery cells, so that a chain reaction of several incidents can be effectively avoided.

The provision of several protective devices for the mechanical and possibly also electrical connection of two groups of battery cells has the advantage that an overdetermination of forces within the battery system is avoided. Leaks can be prevented in this way, particularly in conjunction with a cooling system. However, the protective devices can also be arranged in a common carrier. In this case, either the protective devices can be stored with play in the carrier or the protective devices are rigidly connected to the carrier and the hazard receptacles and, if necessary, protective receptacles allow end sections of the battery cells used in them to be stored with room to move. For example, the common carrier can be a spacer for two battery modules, each of which comprises a group of battery cells.

### BRIEF DESCRIPTION OF THE INVENTION

The subject of the invention is shown in the drawing, for example, wherein

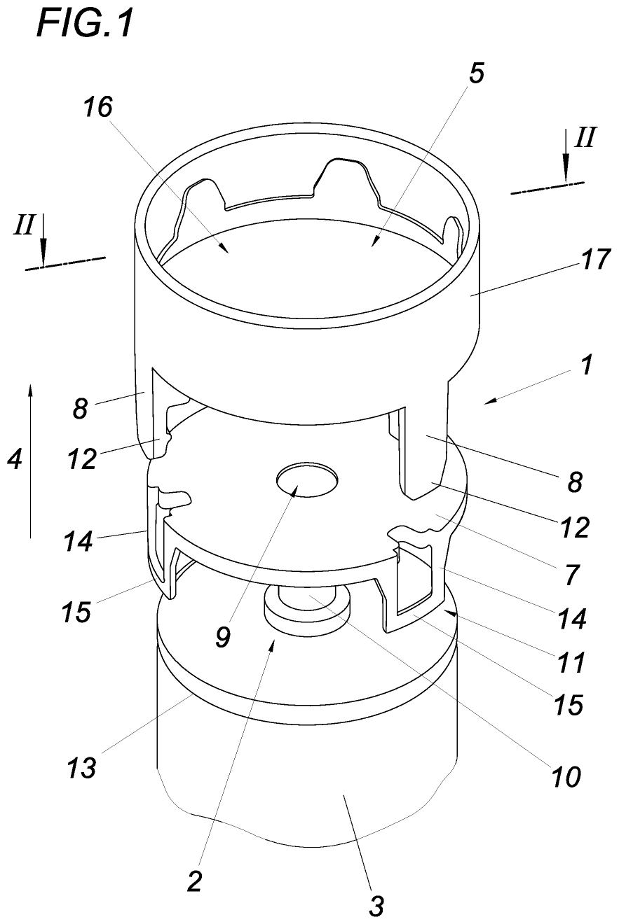

FIG. 1 shows an exploded view of a protective device according to the invention and a battery cell,

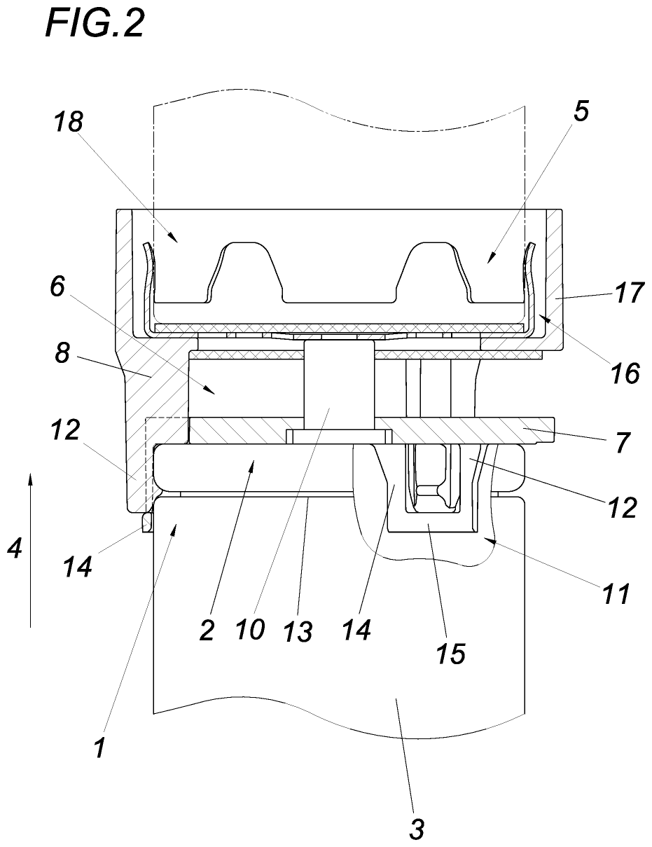

FIG. 2 shows a sectional view of the protective device in the rest position along line II- Il of FIG. 1 with the battery cell inserted in the hazard receptacle on a larger scale,

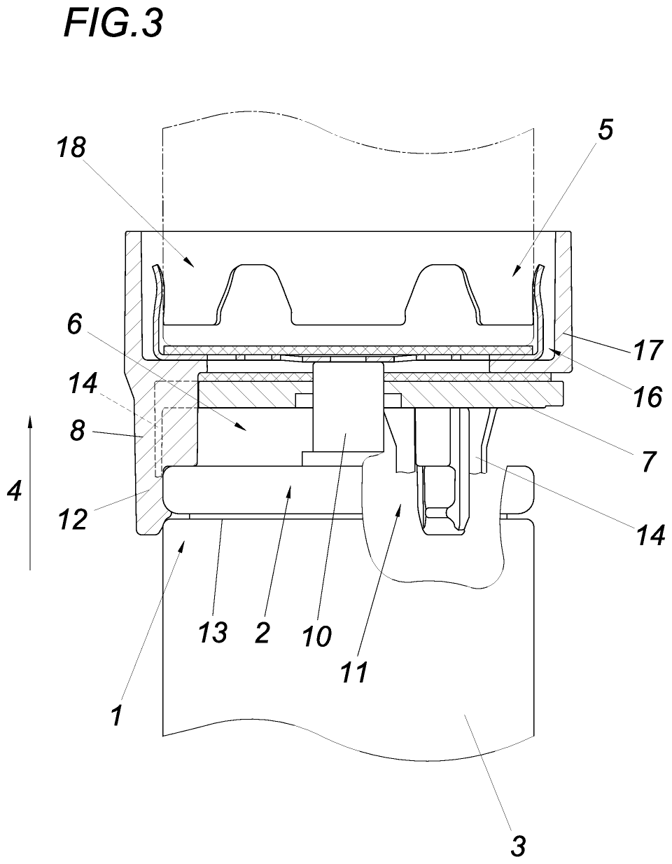

FIG. 3 shows a sectional view of the protective device in the trigger position corresponding to FIG. 2 and

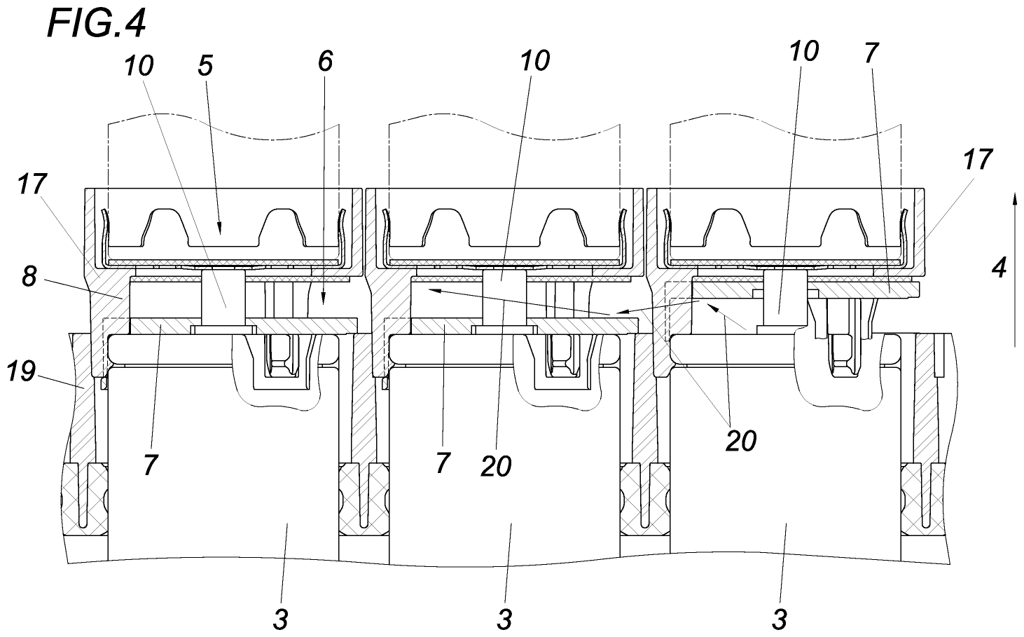

FIG. 4 shows a sectional view of a battery system with a plurality of protective devices according to the invention arranged in a common carrier on a smaller scale.

### DESCRIPTION OF THE PREFERRED EMBODIMENTS

A protective device according to the invention comprises a hazard receptacle 1 for the outgassing region 2 of a battery cell 3 and a protective receptacle 5 located opposite the hazard receptacle 1 in a main direction 4. An outgassing channel 6 runs between the hazard receptacle 1 and the protective receptacle 5, into which hot gases escaping from the battery cell 3 are channelled in the event of a fault. A protective element 7 can be moved along a guide between a rest position and a trigger position.

In the rest position, the protective element 7 covers the hazard receptacle 1 from the outgassing channel 6, as shown in FIG. 2. If hot gases escape from the outgassing area 2 of the battery cell 3 due to a fault in the battery cell 3, they impact on the protective element 7 and transfer some of their kinetic energy to it, causing the protective element 7 to move along the guide from the rest position and allowing the hot gases to access the outgassing channel 6. If sufficient kinetic energy is transferred to the protective element 7 as a result of strong outgassing, it is displaced along the guide into the trigger position, in which the protective element 7 covers the protective receptacle, as shown in FIG. 3.

In terms of production technology, the guide can be easily realised via one or, as shown in the drawing, several guide bars 8, whereby several guide bars 8 also enable a form-fit mounting of the protective element 7 transverse to the main direction 4 and reduce the probability of the protective element 7 tilting during displacement. As the hot gases escape from the outgassing region 2 in a locally concentrated manner, a recess 9 can be provided for a connecting cable 10 to pass through without significantly impairing the functionality of the protective device. It is important that the recess 9 is arranged transversely to the main direction 4, offset to the outgassing region 2, in order to prevent significant quantities of hot gas from escaping through the recess 9 without transferring their kinetic energy to the protective element 7. In addition, the cross-section of the connecting conductor 10 can essentially correspond to the cross-section of the recess 9, whereby the recess 9 is closed by the connecting conductor 10. By way of explanation, it should be noted that the outgassing region 2 in FIGS. 1 to 3 extends radially outwards from the edge of the pole cap connected to the connecting conductor 10. The hot gas therefore does not flow in the direction of the connecting conductor 10, but radially outwards away from it.

To prevent the protective element 7 from being unintentionally released from its rest position during operation, for example due to vibrations, it can be secured against unintentional displacement. Tests have shown that securing against a triggering acceleration of at least 100 g prevents unintentional displacement, but is still sensitive enough to allow displacement induced by escaping hot gases and/or electrically conductive particles. As shown in the drawing, this safeguard can be realised by a predetermined breaking point 11. In the embodiment shown, the protective device is latched via snap-in connections 12 to a groove 13 running around the casing of the battery cell 3. The protective element 7 has one or more retaining tabs 14, which comprise a lug leg 15 extending transversely to the main direction 4. As shown in FIG. 2, the snap-in connections 12 form a stop in the main direction 4 for the lug leg 15 of the retaining tab 14 in the rest position. If the energy transfer from the hot gas to the protective element 7 is so high during degassing that the predetermined breaking point 11 breaks, the lug leg 15 of the retaining tab 14 breaks, as a result of which the stop in the main direction 4 is removed and the protective element is displaced in the main direction 4 by the energy transfer from the hot gas (see FIG. 3).

When several battery cells 3 are arranged to form a battery system, there are further advantages if the hazard receptacle 1, protective element 7 and protective receptacle 5 are arranged concentrically to each other in the main direction 4, as this allows as many battery cells 3 as possible to be densely packed in three spatial directions, thus enabling a high energy density in the battery system. There are further advantages for a battery module if the protective receptacle 5 is formed by the cylindrical recess 16 of a socket 17, as this recess 16 allows another battery cell 3 to be stored in close proximity and easily electrically contacted via its end section 18 in the main direction 4. Furthermore, the socket 17 can form a stop for the protective element 7 in the trigger position, whereby the maximum height of the outgassing channel 6 in the main direction 4 can be defined.

FIG. 4 shows such a battery system with several protective devices according to the invention, which are arranged in a common carrier 19. The carrier 19 forms receptacles into which the individual protective devices can be inserted. As a result of these measures, there is a continuous outgassing channel 6 connecting the individual protective devices with each other, via which hot gases escaping from a battery cell 3 can be discharged in the event of a fault. In FIG. 4, the path of the hot gases is shown schematically by the arrows 20. The protective element 7 in the trigger position in the area of the outgassing battery cell 3 shields the downstream protective receptacle 5 in the main direction 4 from the hot gases, which bounce off this protective element 7 in the trigger position and are deflected in the direction of the neighbouring protective elements. There they hit the protective elements 7 in the rest position, where they are deflected again and discharged via the continuous outgassing channel 6.

1. A protective device for battery cells, said protective device comprising:
a hazard receptacle for the outgassing region of one of the battery cells; and
a protective receptacle located opposite the hazard receptacle in a main direction;
wherein the hazard receptacle and the protective receptacle provide therebetween an outgassing channel extending transversely to the main direction and discharging hot gas; and
a protective element covering the hazard receptacle in a rest position is supported so as to be displaced by escaping hot gas along a guide into a trigger position wherein the protective element covers the protective receptacle.

2. The protective device according to claim 1, wherein the protective element is guided by a guide when displaced, and the guide has a guide bar arranged at an edge of the protective element and extending in the main direction.

3. The protective device according to claim 2, wherein the guide has one or more additional guide bars, said guide bar and additional guide bars being equally distributed on a circumference of the protective element.

4. The protective device according to claim 1, wherein the protective element has a recess providing passage of a connecting conductor, wherein said recess is arranged offset transversely to the main direction with respect to the outgassing region of the battery cell.

5. The protective device according to claim 1, wherein the hazard receptacle, the protective element, and the protective receptacle are arranged concentrically to each other in the main direction.

6. The protective device according to claim 1, wherein the protective element (is secured against displacement from the rest position when a triggering acceleration is less than 100 g.

7. The protective device according to claim 1, wherein a socket having a cylindrical recess therein supports the protective receptacle, the socket having an outer side facing the outgassing channel that forms a stop for the protective element in the trigger position.

8. The protective device according to claim 1, wherein the hazard receptacle comprises a plurality of snap-in connections fixing the battery cell.

9. A battery system having a plurality of protective devices according to claim 1, wherein said protective devises are adjacent to one another transversely to the main direction, wherein end sections a first group of the battery cells are inserted into the hazard receptacles of the protective devices, and end sections of a second group of the battery cells are inserted into the protective receptacles of the protective devices.

10. The battery system according to claim 9, wherein the protective devices are supported in a common carrier.

11. The protective device according to claim 2, wherein the protective element has a recess providing passage of a connecting conductor, wherein said recess is arranged offset transversely to the main direction with respect to the outgassing region of the battery cell.

12. The protective device according to claim 3, wherein the protective element has a recess providing passage of a connecting conductor, wherein said recess is arranged offset transversely to the main direction with respect to the outgassing region of the battery cell.

13. The protective device according to claim 2, wherein the hazard receptacle, the protective element, and the protective receptacle are arranged concentrically to each other in the main direction.

14. The protective device according to claim 3, wherein the hazard receptacle, the protective element, and the protective receptacle are arranged concentrically to each other in the main direction.

15. The protective device according to claim 4, wherein the hazard receptacle, the protective element, and the protective receptacle are arranged concentrically to each other in the main direction.

16. The protective device according to claim 2, wherein a socket having a cylindrical recess supports the protective receptacle therein, the socket having an outer side facing the outgassing channel that forms a stop for the protective element in the trigger position.

17. The protective device according to claim 3, wherein a socket having a cylindrical recess supports the protective receptacle therein, the socket having an outer side facing the outgassing channel that forms a stop for the protective element in the trigger position.

18. The protective device according to claim 4, wherein a socket having a cylindrical recess supports the protective receptacle therein, the socket having an outer side facing the outgassing channel that forms a stop for the protective element in the trigger position.

19. The protective device according to claim 5, wherein a socket having a cylindrical recess supports the protective receptacle therein, the socket having an outer side facing the outgassing channel that forms a stop for the protective element in the trigger position.
